(19) United States
(12) Patent Application Publication
(10) Pub. No.: US 2001/0023469 A1
(43) Pub. Date: Sep. 20, 2001

(54) Distributed type input buffer switch system for transmitting arbitration information efficiently and method for processing input data using the same

(76) Inventors: Gab-Joong Jeong, Taejon (KR); Jung-Hee Lee, Taejon (KR); Bhum-Cheol Lee, Taejon (KR); Kwon-Chul Park, Taejon (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/749,795

(22) Filed: Dec. 28, 2000

(30) Foreign Application Priority Data
Mar. 20, 2000 (KR) 2000-14113

(51) Int. Cl. G06F 13/00

(52) U.S. Cl. 710/241; 710/131

(57) ABSTRACT

A distributed type input buffer switch system includes at least one input data processing unit matched to an input port for storing and managing input data by target output ports, requesting arbitration for switching, and storing and managing information on an arbitration-requested data; an arbitration unit for managing an arbitration request signal received from the input data processing unit according to the input data processing unit and the target output port and performing arbitration according to an arbitration request; and a switching unit for receiving data from the input data processing unit and transmitting the same to the output ports by performing switching according to a command from the arbitration unit.

### FIELD OF THE INVENTION

The present invention relates to a distributed type input buffer switch system having arbitration latency tolerance and method for processing input data using the same, and more particularly, to a distributed type input buffer switch system having arbitration latency tolerance and method for processing input data using the same in which a central arbiter gathers transmission requests from multiple input ports, determines as many grants as possible from each output port shared by all the input ports within a short time, and transmits the result to distributed input buffers each at a high speed.

### DESCRIPTION OF THE PRIOR ART

In a distributed type input buffer switch, the throughput of the switch is determined by a high speed input buffer and central arbiter. Generally, the total arbitration time of the central arbiter means the sum of a transmission time during which a new request signal to be arbitrated for one input data is received from each input buffer, an actual arbitration time, and a time during which a grant signal generated by using an arbitration result is transmitted to each input buffer. In case of the central arbiter operating at a high speed, it must receive more transmission request signals from input buffers, and must transmits more grant signals to all the input buffers.

FIG. 1 is an exemplary block diagram of a conventional distributed input buffer switch system.

The conventional distributed type input buffer switch system includes N number of input buffers(B₁ through B_{N}) 11, a central arbiter 12, and a space division switch 13. Each input buffer 11 has a plurality of virtual output queues(VOQ) 111 corresponding to the number of output ports.

FIG. 1 is a view illustrating the structure of the switch system in which transmission of a transmission request signal, arbitration thereof, and transmission of a grant signal are achieved every unit data packet processing time according to the conventional art. Here, as the data packet transmission speed of each input and output port becomes higher, each unit data packet processing time becomes shorter. And, it is difficult for even the high speed central arbiter 12 to complete request signal transmission, arbitration, and grant signal transmission between each input buffer 11 and the central arbiter 12 within such a short unit data packet processing time.

In other words, in the conventional art, it is made possible to transmit an arbitration request signal for the next input data of the input buffer only after arbitration request signal transmission, arbitration, and grant signal transmission for one data in the input buffer are achieved. Thus, in a case that the number of input buffers is large, or the amount of request and grant signal data is large, a transmission latency frequently occurs.

### SUMMARY OF THE INVENTION

Accordingly, it is an object of the present invention to provide a distributed type input buffer switch system having arbitration latency tolerance and method for processing input data using the same which performs arbitration for a request generated irrespective of a transmission latency of request signals and grant signals by having a double FIFO(first-in-first-out) buffer at an input buffer and having a request FIFO buffer at a central arbiter.

To achieve the above object of the present invention, there is provided a distributed type input buffer switch system according to the present invention, which includes: at least one input data processing unit matched to an input port for storing and managing input data by target output ports, requesting arbitration for switching, and storing and managing information on an arbitration-requested data; an arbitration unit for managing an arbitration request signal received from the input data processing unit according to the input data processing unit and the target output port and performing arbitration according to an arbitration request; and a switching unit for receiving data from the input data processing unit and transmitting the same to the output ports by performing switching according to a command from the arbitration unit.

In addition, there is provided a method for processing input data adapted to the distributed-type input buffer switch system according to the present invention, which includes: a first step in which an input data processing unit stores and manages an input data received from a matched input port; a second step in which the input data processing unit transmits an arbitration request signal for the input data and storing and managing information on the input data for which the arbitration request signal is transmitted; a third step in which an arbitration unit manages the transmitted arbitration request signal according to the input data processing unit and the target output port; a fourth step in which arbitration is performed by checking an arbitration request according to the input data processing unit and the target output port and the result is transmitted to the input data processing unit and the switching unit; and a fifth step in which the input data processing unit performs processing of the input data by checking information on the stored input data upon receipt of an output grant signal and transmitting the same to the switching unit.

To solve an effective arbitration problem of a central arbiter and a high throughput support problem of a switch inevitably requested for a self-routing switch system having distributed type input buffers, there is provided a pipelined, distributed type switch system operating at a high speed according to the present invention. Each input buffer has queues by output ports, supports a virtual output queue for queuing input data cells for each output port, and has a cell address FIFO(first-in-first-out) buffer for each output port.

When there is a queued cell corresponding to each output port, the input buffer sends a transmission request signal of the corresponding output port to the central arbiter, and at the same time reads out the address of the queued cell from the VOQ for thereby moving the same to the cell address FIFO buffer. The central arbiter has a transmission request signal FIFO buffer and an arbitration logic, and stores request signals transmitted from all input buffers to the FIFO buffer. The arbitration logic block of the central arbiter arbitrates between all request signals stored in the request signal FIFO buffer, and generates a grant signal according to the result of the arbitration within one unit data packet processing time. The generated grant signal is transmitted to each input buffer, and the input buffer outputs a cell using an output cell address in the cell address FIFO buffer for each output port according to the grant signal. In all methods proposed in the present invention, the system operates based on unit data packet processing time, and processes a large volume of transmission request signals by a pipeline operation for each unit. In each method, the system is configured to tolerate transmission latency generated in each block and to support a high throughput of the switch.

That is, in the present invention, arbitration request transmission, arbitration, and arbitration result transmission are separately performed, and an arbitration request for the next input data can be performed by separately storing an arbitration requested data.

Additional advantages, object and features of the invention will become more apparent from the description which follows.

### BRIEF DESCRIPTION OF THE DRAWINGS

The present invention will become better understood with reference to the accompanying drawings which are given only by way of illustration and thus are not limitative of the present invention, wherein:

FIG. 1 is an exemplary block diagram of a conventional distributed input buffer switch system;

FIG. 2 is a block diagram of a distributed type input buffer switch system having arbitration latency tolerance according to a first embodiment of the present invention;

FIG. 3 is a detail block diagram of an input buffer according to the first embodiment of the present invention;

FIG. 4 is a flow chart for an arbitration request signal generation process for an input data of a virtual output queue according to the first embodiment of the present invention;

FIG. 5 is a flow chart for a step of processing a grant signal in an input buffer according to the first embodiment of the present invention;

FIG. 6 is a detail block diagram of a central arbiter according to the first embodiment of the present invention;

FIG. 7 is a flow chart for a step of processing an arbitration request signal according to the first embodiment of the present invention;

FIG. 8 is an explanatory view for a request vector generation in the step of processing an arbitration request signal according to the first embodiment of the present invention; and

FIG. 9 is a process timing diagram of the distributed type input buffer switch system having arbitration latency tolerance according to the first embodiment of the present invention.

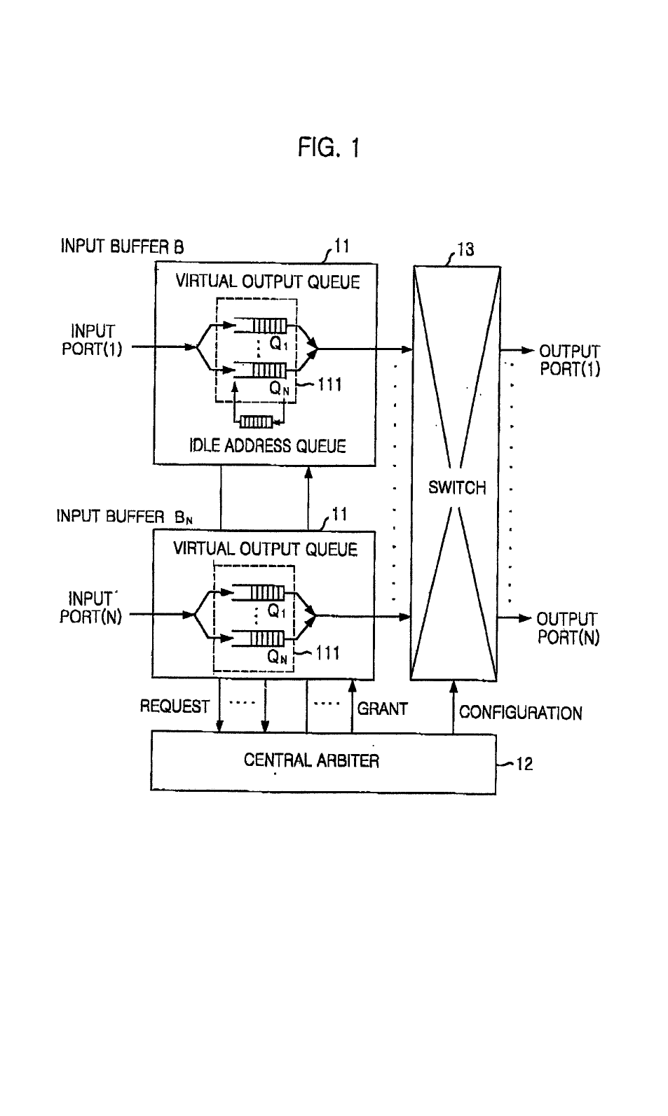

### DETAILED DESCRIPTION OF THE PREFERRED EMBODIMENTS

The preferred embodiment of the present invention will now be described with reference to the accompanying drawings.

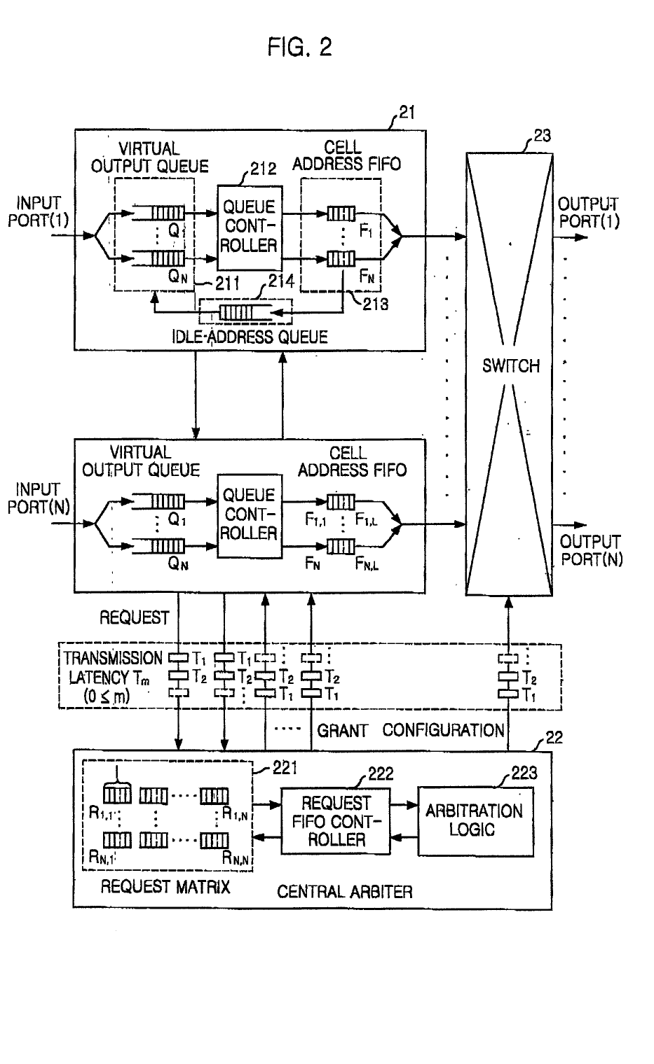

FIG. 2 is a block diagram of a distributed type input buffer switch system having arbitration latency tolerance according to a first embodiment of the present invention.

The distributed type input buffer switch system having arbitration latency tolerance according to the present invention includes a plurality of input buffers Bᵢ(1≦i≦N) 21 corresponding to input ports; a central arbiter 22 for performing arbitration; and a space division switch 23 for switching data inputted according to a given command.

The input buffer Bᵢ(1≦i≦N) 21 includes: a virtual output queue(VOQ) Qᵢ(1≦i≦N ) 211; a queue controller 212; a cell address FIFO(CAF) buffer F_{i,j} (1≦i≦N , 1≦j≦N ) 213; and an idle queue 214. The central arbiter 22 includes: a request matrix 221; a request FIFO controller(RFC) 222; and an arbitration logic 223.

As illustrated in FIG. 2, the input buffers 21 has output cell address FIFO buffers 213 each matched to the virtual output queues 211. In addition, the central arbiter 22 has a request matrix 221 for storing a request signal per output port by input buffers, besides the arbitration logic 223. This request matrix 221 has a request FIFO(RF) buffer R_{i,j,k}(1≦i≦N, 1≦j≦N, 1≦k≦L) 2211 for each request matrix element.

The present invention is a switch system which supports a high throughput without affecting the performance of the switch for a physical or logical reason during data transmission generated between the input buffer 21 and the central arbiter 22, even in a case that there are m(0≦m) number of transmission latency T.

The case of no transmission latency corresponds to transmission latency T₀. The size L of the output cell address FIFO buffer(CAF buffer) 213 existing in the input buffer 21, and each request FIFO buffer 2212 has no connection with the number of transmission latency, and can be increased or decreased for enhancement in performance.

As illustrated in the drawings, since the distributed type input buffer switch system having arbitration latency tolerance of the invention has the CAF buffer 213 and the request matrix 221, it has a high speed processing time by distributed-queuing input data for switching.

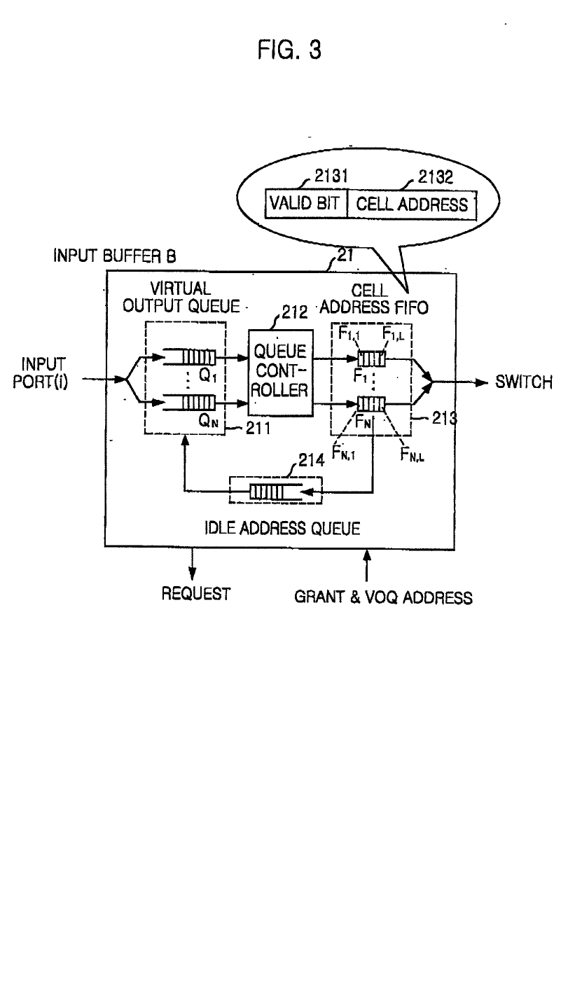

FIG. 3 is a detail block diagram of an input buffer according to the first embodiment of the present invention.

The input buffer Bᵢ(1≦i≦N ) 21 as shown in FIG. 3 includes: a virtual output queue(VOQ) Qᵢ(1≦i≦N) 211 for queuing up for data packets arrived at the input buffer 21 by target ports for each data packet, a queue controller(QC) 212; a cell address FIFO buffer(CAF buffer) F_{i,j}(1≦i≦N ,1≦k≦L)213; and an idle queue 214. Here, N designates the size of the switch, and L designates the length of the FIFO buffer.

One element of the output cell address FIFO buffer 213 includes a cell address 2132 to be outputted and a valid bit 2131 indicating if the current output address is a valid address.

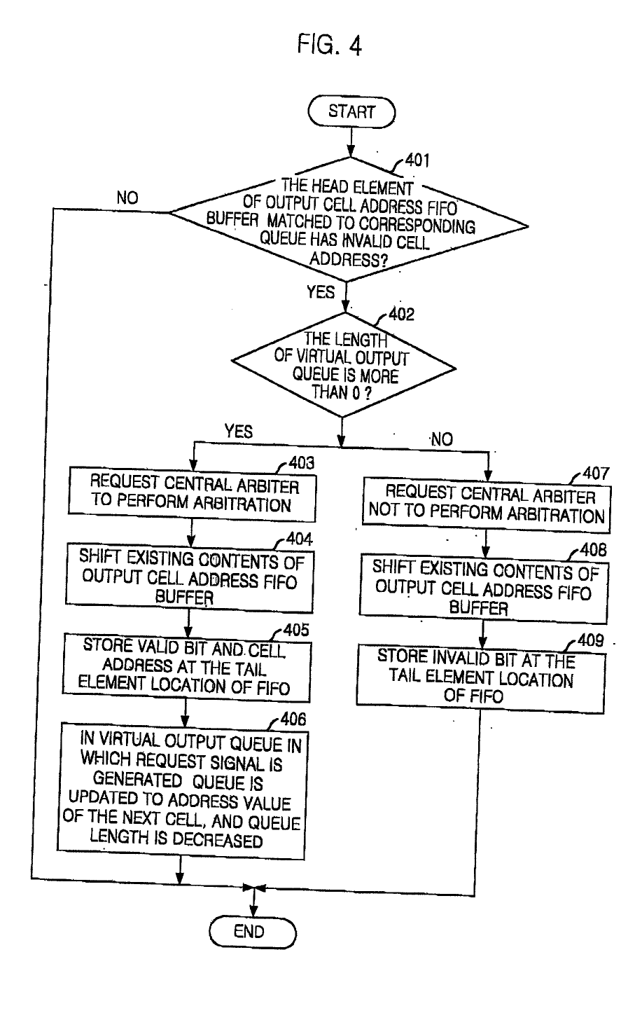

FIG. 4 is a flow chart of a step of generating an arbitration request signal for input data of a virtual output queue according to the first embodiment of the present invention.

The step of generating an arbitration request signal for data of a virtual output queue(VOQ) 211 in each input buffer according to the present invention is illustrated as the flow chart in FIG. 4.

When the length of the virtual output queue 211 is more than 0, that is, when, a data cell is queued in the virtual output queue 211, an arbitration request signal can be generated. Only when the head element of the output cell address FIFO buffer 213 matched to the corresponding queue, a request signal is generated to the central arbiter 22. In other cases, no request signal is generated. In other words, the output cell address FIFO buffer 213 is closely filled with L number of information of data for which an arbitration request signal is generated, an arbitration request signal for the next input data is not generated. Here, the head element of the output cell address FIFO buffer 213 means the location of the buffer in which the last cell address is filled, e.g., F_{i,L} for Qᵢ, because the address of a corresponding cell having input data is filled in, starting from the tail element location of the output cell address FIFO buffer 213.

In addition, only when an arbitration request signal for data of each virtual output queue (VOQ) 211 is generated, the existing contents of the corresponding output cell address FIFO 213 is shifted while being stored in the tail element location F_{i,l} of the FIFO 213 by reading out the address of the corresponding cell from the virtual output queue(VOQ) 211. The valid bit of the corresponding element is stored as valid. At this time, to check the valid bit as valid is to indicate that the cell address of an arbitration-requested cell address is stored.

In the virtual output queue 211 in which the arbitration request signal is generated, data to be processed is updated to the address value of the next cell, and the queue length is decreased.

This will be described with the flow of the drawing.

First, it is checked the head element of the output cell address FIFO buffer 213 matched to the corresponding queue has an invalid cell address in step 401. At this time, the invalid cell address means that there is no cell address of an arbitration-requested data. That is, it is checked if the output cell address FIFO buffer 213 is closed filled.

As the result of the checking, if the head element of the output cell address FIFO buffer has a valid cell address, the step of generating an arbitration request signal from the input buffer 21 to the central arbiter 22 is omitted.

As the result of checking, if the head element of the output cell address FIFO buffer has the invalid cell address, it is checked if the length of the virtual output queue 211 is more than 0 in step 402.

As the result of checking, if the length of the virtual output queue 211 is more than 0, an arbitration request signal is generated and transmitted to the central arbiter 22 in step 403.

The existing contents of the output cell address FIFO buffer 213 is shifted by one element in step 404.

The cell address is stored in the tail element location of the FIFO buffer by reading out the same from the virtual output queue 211, and the valid bit is checked as valid in step 405.

With the respect to the virtual output queue 211 in which the arbitration signal is generated, the queue is updated to the address value of the next cell, and the queue length is decreased in step 406.

As the result of checking in step 402, if the length of the virtual output queue 211 is 0, a request signal not to perform the arbitration is generated and transmitted to the central arbiter 22 in step 407.

In step 408, the existing contents of the output cell address FIFO buffer 213 is shifted by one element.

“0” representing invalid is stored in the tail element location of the FIFO buffer in step 409.

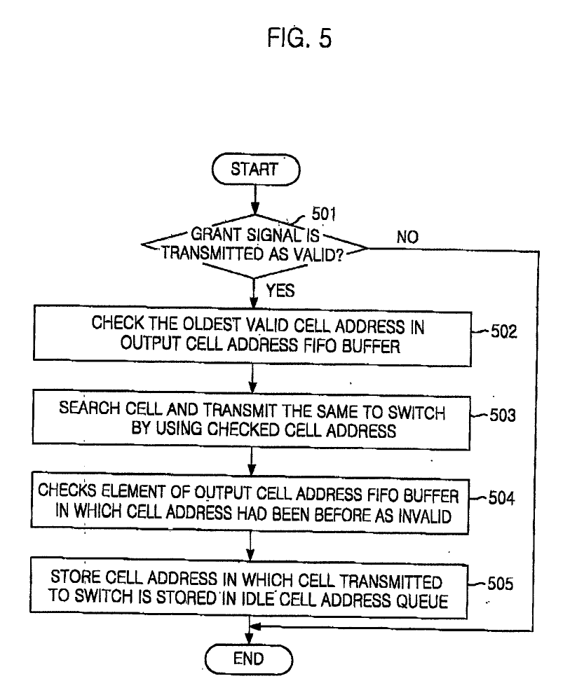

FIG. 5 is a flow chart for a step of processing a grant signal in an input buffer according to the first embodiment of the present invention.

The step of processing a grant signal transmitted from the central arbiter and a grant signal for an output queue address in each input buffer is illustrated as the flow chart in FIG. 5.

The CAF 213 of the input buffers 21 aligned by output ports receives a valid grant signal, in a case that arbitration is performed by the central arbiter 22, or receives an invalid grant signal, in a case that arbitration is not performed by the central arbiter 22.

If the grant signal is transmitted to the output cell address FIFO buffer 213 as valid, an output cell is transmitted to the corresponding output port by reading out the same from a cell buffer memory using the earliest valid cell address among queuing valid cell addresses. The address value of the transmitted cell in the cell buffer memory returns to the idle cell address queue 214, and it is indicated that there is no cell address stored in the corresponding element of the output cell address FIFO buffer to be processed by updating the valid bit to an invalid value.

At this time, with respect to the output cell address FIFO buffer granted by using a grant signal transmitted from the central arbiter, the earliest valid cell address element in the granted output cell address FIFO buffer is updated to an invalid cell address by using a leading one detection FIFO buffer.

Here, the valid cell is referred to as a cell matched to the cell address queuing for switching in the CAF 213 and actually stored in the cell buffer memory, so as to be outputted through the output ports.

This will be described with the flow of the drawing.

The CAF 213 checks if a grant signal is checked as valid to be transmitted in step 501. In other words, it checks if a cell, e.g., an input data, is granted to be transmitted from the corresponding CAF 213 to the output ports.

As the result of the checking, if the grant signal is transmitted as valid, the oldest valid cell address in the output cell address FIFO(CAF) buffer 213 is confirmed in step 502, and the cell, e.g., the data to be outputted, is searched by using the confirmed cell address to thus be transmitted to the switch 23 in step 503.

It is indicated that there is no cell address to be processed in the corresponding element of the output cell address FIFO buffer in step 504, and the cell address of the cell transmitted to the switch is stored in the idle cell address queue in step 505. The idle cell address queue 214 stores the cell address, and then provides it to the input buffer 21 so as to store a new input data inputted to the input buffer 21.

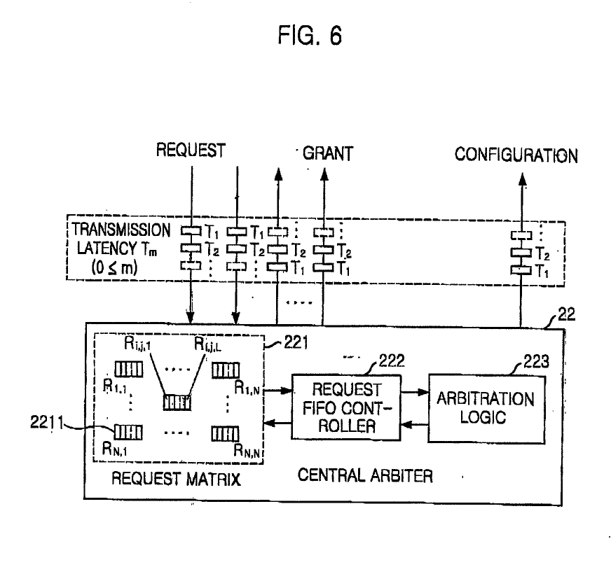

FIG. 6 is a detail block diagram of a central arbiter according to the first embodiment of the present invention.

The central arbiter 22 having a request FIFO(first-in-first-out) buffer 2211 operating along with the output cell address FIFO(first-in-first-out) 213 managed by the input buffer 21 is illustrated in FIG. 6.

The central arbiter 22 includes: an arbitration logic 223 for performing arbitration; a request matrix 221 for storing a transmitted request signal for each output port by input buffers; and a request FIFO controller(RFC) 222 for controlling information in the request matrix 221 and associating the request matrix 221 with the arbitration logic 223.

At this time, in the request matrix 221, there are request FIFO buffers R_{i,j,k} (1≦i≦N , 1≦j≦N, 1≦k≦N) 2211 for storing request signals transmitted from all input buffers.

The size L of each request FIFO buffer 2211 in the request matrix 221 is identical to that of the output cell address FIFO buffer 213. This is because, if all arbitration-requested cell addresses are filled in the output cell address FIFO buffer 213, the input buffer 21 does not generate an arbitration request signal any more. Of course, the size L of the FIFO buffer is variable.

A request signal generated from each output queue of each input buffer is stored in the request FIFO buffer dependant from all other input buffers and all other output queues. For example, a single stored request signal R_{i,j,k} designates a k-th request FIFO buffer element of a j-th output queue Qⱼ of an i-th input buffer Bᵢ.

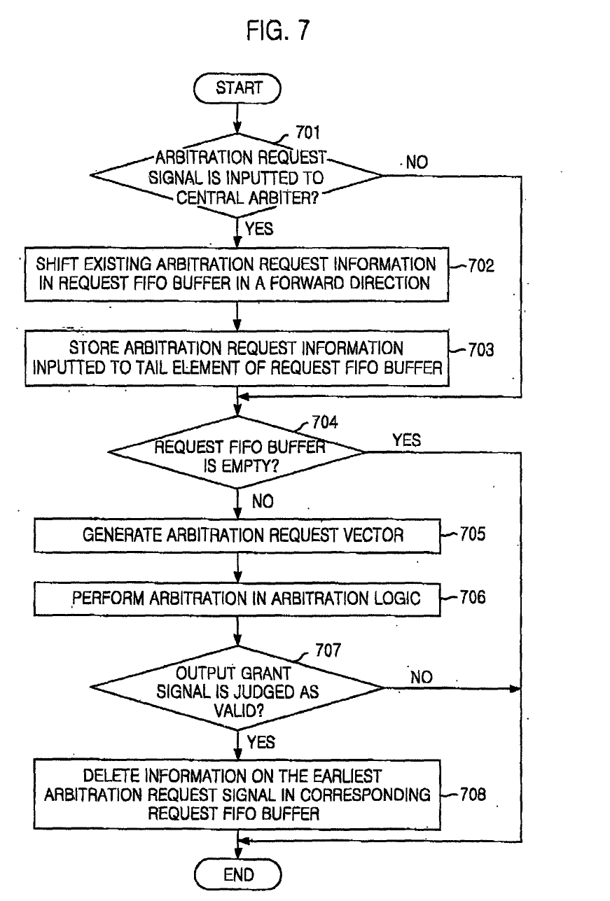

FIG. 7 is a flow chart for a step of processing an arbitration request signal according to the first embodiment of the present invention.

The step of processing a request signal transmitted from the input buffer 21 in the central arbiter 22 of the present invention is illustrated as the flow chart in FIG. 7.

The central arbiter 22 receives arbitration request signals from all input buffers 21 with respect to all output ports.

In a case that there is a request signal, it is indicated that an arbitration request is received from the cell address buffer showing the corresponding output port of the corresponding input buffer by shifting the existing contents of the request FIFO buffer of the corresponding request matrix element and updating the tail element of the request FIFO buffer as valid.

An arbitration logic input request vector required for the arbitration logic 23 in the central arbiter 22 generates a single request signal for each request FIFO buffer 2211, and the thusly generated request signal is inputted to the arbitration logic 223 by the request vector for all input buffers.

If a grant signal is generated by allocating the output ports for each input port by the arbitration logic 223, the earliest request element having a valid request in the contents of the request FIFO buffer for the corresponding output port of the corresponding input buffer is updated as an invalid request according to each grant signal, and the fact that the grant signal is generated is transmitted to the corresponding output cell address FIFO buffer of the corresponding input buffer. At this time, the fact of being updated as an invalid request means that processing of the corresponding element is achieved, and a new request data can be received.

This will be described with the flow of the drawing.

First, the central arbiter 22 checks if there is an arbitration request signal inputted from output queue Qⱼ of input buffer Bᵢ in step 701. As the result of the checking, if there is an arbitration request signal, the existing arbitration request information in the request FIFO buffer 2211 is shifted in a forward direction in order to store the arbitration request signal in the corresponding request FIFO buffer 2211 in the request matrix 221 in step 702, and the arbitration request information inputted to the tail element of the request FIFO buffer 2211 is stored in step 703. If processing of the inputted arbitration request signal is completed, the step of checking if the request FIFO buffer 221 is empty in step 704 is performed.

As the result of checking if any arbitration request signal is inputted from the central arbiter 22, if there is no arbitration request signal, the step of checking if the request FIFO buffer 221 is empty in step 704 is performed.

As the result of the checking, if there is no arbitration request information because the request FIFO buffer 2211 is empty, the step of processing an arbitration request in this clock is finished.

As the result of the checking, if there is any arbitration request signal because the request FIFO buffer is not empty, an arbitration request vector is generated in step 705 for thereby performing arbitration in the arbitration logic 223 of the central arbiter 22 in step 706. After performing the arbitration, it is judged if an output grant signal is valid for the arbitration request signal inputted from output queue Qⱼ of input buffer Bᵢ corresponding to the request FIFO buffer 2211 in step 707. As the result of the checking, if the output grant signal is valid, the arbitration request vector empties the request FIFO buffer 2211 by deleting the information on the earliest arbitration request signal from the corresponding request FIFO buffer 2211, and queues for the next arbitration request signal.

As the result of the checking, if the output grant signal is not checked as valid, the step of processing an arbitration in this clock is finished.

The step of processing an arbitration request in the central arbiter represents the step of processing an arbitration request in the request FIFO buffer corresponding to the corresponding input buffer and the corresponding output port.

After the arbitration is performed in the arbitration logic, a grant signal is generated to be transmitted to the corresponding output cell address FIFO buffer of the corresponding input buffer, whether the grant signal is judged as valid or invalid.

At this time, in processing of data of the request FIFO buffer for the output grant signal, with respect to the request FIFO buffer granted by using a grant signal generated by the arbitration logic 223, the earliest request element having a valid request is simply updated to an invalid request by using a leading one detection logic.

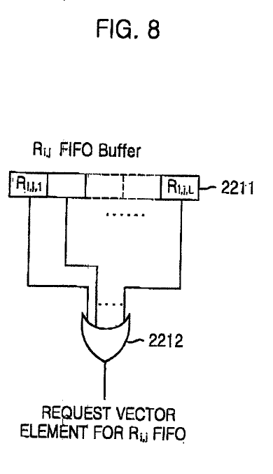

FIG. 8 is an explanatory view for a request vector generation in the step of processing an arbitration request signal according to the first embodiment of the present invention.

The request vector transmitted to the arbitration logic 223 from the request FIFO buffer 2211 for each input buffer judges if there is a valid request data in the FIFO buffer by using a simple OR logic 2212 as in FIG. 8. If there is any valid request data, the corresponding data of the request vector is generated as a valid request.

FIG. 9 is a process timing diagram of the distributed type input buffer switch system having arbitration latency tolerance according to the first embodiment of the present invention.

To help to understand a pipeline operation achieved by engagement of operations by function blocks, the timing diagram of the step in which an arriving cell is transmitted to output ports via the arbitration latency tolerant switch according to the present invention is illustrated in FIG. 9 as an example of a switch having one cell slot of request signal transmission latency, one cell slot of grant signal transmission latency, and one cell slot of arbitration latency. Here, pipeline stage 0 designates an input buffer stage, pipeline stage 1 designates a request signal transmission latency state, pipeline stage 2 designates an arbitration latency of the central arbiter, and pipeline stage 3 designates a grant signal transmission latency.

At the input buffer stage of pipeline stage0, it is shown that the arrival and departure of an ingress cell and an egress cell occur at the same time. And, at time slot S4 to which a fifth cell is inputted, it is shown that a cell inputted from time slot S0 is transmitted via its output port. That is, FIG. 9 illustrates a 4-stage pipelined architecture in which the cell delay time in the switch equals to three units of cell time.

Although the present invention has been explained based on the preferred embodiment, it may include a distributed type shared input buffer switch in which one input buffer is shared by g-number of input ports. That is, the present invention may be adapted to a distributed type shared input buffer switch, including input buffers Bᵢ(1≦i≦N /g) each having a virtual output queue Qᵢ(1≦i≦N ) 211 and an output cell address FIFO buffer F_{i,j}(1≦i≦N, 1≦k≦L), and a central arbiter having request FIFO buffers R_{i,j,k}(1≦i≦N/g, 1≦j≦N,1≦k≦L) each having a shared input buffer and a request FIFO buffer for each output cell address FIFO.

In addition, although the present invention has been explained based on the preferred embodiment, it may include transmission latency of a request signal and grant signal generated in a bus type transmission line in which the central arbiter is connected with all input buffers.

In addition, although the present invention has been explained based on the preferred embodiment, it may include the case of using an adding and subtracting counter in place of the request FIFO 221 in the central arbiter, and the case of searching the earliest valid cell address in the output cell address FIFO by using the adding and subtracting counter in place of the valid bit 2131 contained in the output cell address FIFO(CAF) in the input buffer.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

According to the present invention described above, there is an effect of supporting a high speed operation by completing all operations within the processing time of each unit data packet using a modular design unit in which each function block is modularized and a pipelined design unit in which data transmission between each function block is pipelined, and transmitting the result of each function block by a pipeline operation, while preventing an operational error, such as disarrangement of the order of ingress cells to be routed from the switch to a target output port, due to a latency effect generated by the pipeline operation, for thereby increasing the throughput of the switch.

In addition, according to the present invention, a high throughput support problem which is difficult to be solved in the conventional distributed type input buffer switch system can be solved by using a construction having an output cell address FIFO in each input buffer and a request matrix in the central arbiter, and a large scale switch can be designed at a low cost by supporting a high speed operation using a pipeline operation, which is followed by the following effects.

First, it is possible to transmit a plurality of request signals per unit cell processing time at a high speed irrespective of the amount of transmission latency of request signals transmitted from a lot of input buffers to the central arbiter, and it is possible to transmit a lot of grant signals per unit cell processing time at a high speed irrespective of the amount of transmission latency of request signals transmitted from the central arbiter to the plurality of input buffers.

Second, a window based arbitration of valid requests is made possible at each arbitration by generating only one request signal per cell with respect to cells in each virtual output queue of all input buffers to thus send it to the central arbiter, storing a non-granted request signal in the central arbiter, and using the same as a continuously valid request at the next arbitration.

Third, the distributed type input buffer switch of the present invention performs arbitration by having a simply-structured output cell address FIFO buffer in each input buffer and a simple request FIFO buffer in the central arbiter fundamentally supports a high throughput, such as that of an output buffer switch which is difficult to be supported by other distributed type input buffer switches, irrespective of an arbitration algorithm.

What is claimed is:

1. A distributed type input buffer switch system, comprising:
at least one input data processing means matched to an input port for storing and managing input data by target output ports, requesting arbitration for switching, and storing and managing information on an arbitration-requested data;
an arbitration means for managing an arbitration request signal received from the input data processing means according to the input data processing means and the target output port and performing arbitration according to an arbitration request; and
a switching means for receiving data from the input data processing means and transmitting the same to the output ports by performing switching according to a command from the arbitration means.

2. The system according to claim 1, wherein the input data storing means comprises:
at least one first input information storing means for storing and managing input data inputted through the input ports by output ports;
at least one second input information storing means matched to the first input information means for storing and managing information on an arbitration-requested data for switching by output ports; and
an input information control means for transmitting an arbitration request signal for an input data stored and managed by the first input information storing means and controlling the data for which the arbitration request signal is transmitted to be stored and managed by the second input information storing means.

3. The system according to claim 2, wherein the input data storing means further comprises:
means for transmitting the arbitration request signal for the input data to the arbitration means, if the second input information storing means has any free space for storing information because the cell address information on more than the predetermined number of input data is not stored in the second input information storing means, wherein the input data are managed and stored by the first input information storing means and are queuing for an arbitration;
means for shifting existing cell address information stored in the second input information storing means;
means for storing sequentially the cell address information on the input data in the second input information storing means according to an input order; and
means for changing information on data to be processed to thereby process an arbitration request for the next input data in a queue.

4. The system according to claim 2, wherein the input data storing means another further comprises:
means for checking a cell address of the oldest input data stored and managed by the second input information storing means;
means for searching and transmitting the input data to the switching means by using the checked cell address;
means for indicating that there is no cell address that is stored and managed in a corresponding element of the second input information storing means in which a cell address had been stored before;
means for storing the cell address from the second input information storing means in an idle cell address storing means in order to store new input data, if the new input data is inputted to the input data processing means.

5. The system according to claim 2, wherein the arbitration means comprises:
at least one request information storing means for storing and managing a transmission request signal transmitted from the input data processing means;
an arbitration processing means for processing arbitration so that switching of an arbitration request information stored in the request information storing means is performed;
an arbitration request control means for requesting the arbitration processing means to perform arbitration by checking if an arbitration request information is stored in the request information storing means.

6. The system according to claim 5, wherein the first input information storing means, second input information storing means, and request information storing means sequentially manage a given data according to an input order.

7. The system according to claim 5, wherein the transmission of data and signals is achieved by a pipeline operation between elements.

8. In a method for processing input data adapted to a distributed-type input buffer switch system, a method for processing input data, comprising:
a first step in which an input data processing means stores and manages an input data received from a matched input port;
a second step in which the input data processing means transmits an arbitration request signal for the input data and storing and managing information on the input data for which the arbitration request signal is transmitted;
a third step in which the arbitration request signal transmitted to an arbitration means is managed according to the input data processing means and the target output port;
a fourth step in which arbitration is performed by checking an arbitration request according to the input data processing means and the target output port and the result is transmitted to the input data processing means and a switching means; and
a fifth step in which the input data processing means performs processing of the input data by checking information on the stored input data upon receipt of an output grant signal and transmitting the same to the switching means.

9. The method according to claim 8, wherein the first step further comprises:
a sixth step in which the input data processing means receives an input data from the input port matched thereto; and
a seventh step in which the input data is stored and managed by a corresponding first input information storing means by target output ports.

10. The method according to claim 9, wherein the second step further comprises:
an eighth step in which it is checked if information on more than a predetermined number of input data is stored in the second input information storing means being matched to the first input information storing means and storing information on an input data transmitted by generating an arbitration request signal, in order to perform an arbitration request for data of which an arbitration request signal is not generated, among input data managed and stored by the first input information storing means; and
a ninth step in which the eighth step is repeatedly performed after a predetermined time, if the information on more than the predetermined number of input data is stored, as the result of the checking in the eighth step; and
a tenth step in which an arbitration request signal for an input data of which an arbitration request is not performed is transmitted to the arbitration means, and the information on the data is stored in the second input information storing means, if the information on more than the predetermined number of input data is not stored, as the result of checking in the eight step.

11. The method according to claim 10, wherein the tenth step further comprises:
an eleventh step in which an arbitration request signal for the input data managed and stored by the first input information storing means and queuing for an arbitration is transmitted to the arbitration means, if the second input information storing means has any free space for storing information because the cell address information on more than the predetermined number of input data is not stored in the second input information storing means;
a twelfth step in which the existing cell address information stored in the second input information storing means is shifted, and the cell address information on the input data is sequentially stored in the second input information storing means according to an input order; and
a thirteenth step in which the first input information storing means changes information on data to be processed so that it can process an arbitration request for the next input data in a queue.

12. The method according to claim 8, wherein the third step further comprises:
a sixth step for checking the input data processing means and target output port of the arbitration request signal transmitted to the arbitration means;
a seventh step for shifting the existing arbitration request information from the request information storing means corresponding to the checked input data processing means and target output port; and
an eighth step for sequentially storing the transmitted arbitration request signal in the request information storing means according to an input order.

13. The method according to claim 8, wherein the fourth step further comprises:
a sixth step for checking if an arbitration request information is stored in the request information storing means according to the input data processing means and target output port.
a seventh step for generating an arbitration request vector for the request information storing means having arbitration request information to thus transmit the same to an arbitration processing means;
an eighth step for performing an arbitration by checking the arbitration request vector from each request information storing means by the arbitration processing means;
a ninth step for transmitting the result of performing the arbitration to the input data processing means and a switching means; and
a tenth step for deleting the oldest arbitration request information of the arbitration request information stored in the request information storing means, which is arbitrated to be granted to be outputted.

14. The method according to claim 13, wherein the fifth step further comprises:
a fourteenth step in which the input data processing means having received an output grant signal from the arbitration means checks the cell address of the oldest input data stored and managed by the second input information storing means;
a fifteenth step in which the input data is searched and transmitted to the switching means by using the checked cell address;
a sixteenth step in which it is indicated that there is no cell address stored and managed in the corresponding element of the second input information storing means in which a cell address had been stored before;
a seventeenth step in which, if a new input data is inputted to the input data processing means, the cell address from the second input information storing means is stored in an idle cell address storing means so as to stored the input data.
